(19) United States
(12) Patent Application Publication
(10) Pub. No.: US 2012/0029137 A1
(43) Pub. Date: Feb. 2, 2012

(54) LONG-FIBER REINFORCED POLYESTERS

(75) Inventors: Sachin Jain, Jalgaon (IN); Sameer Nalawade, Mannheim (DE); Andreas Wollny, Ludwigshafen (DE); Angelika Homes, Laudenbach (DE); Gerhard Leiter, Weinheim (DE); Motonori Yamamoto, Mannheim (DE)

(73) Assignee: BASF SE, Ludwigshafen (DE)

(21) Appl. No.: 13/196,028

(22) Filed: Aug. 2, 2011

Related U.S. Application Data
(60) Provisional application No. 61/369,771, filed on Aug. 2, 2010.

(51) Int. Cl. C08K 3/40

(52) U.S. Cl. 524/494

(57) ABSTRACT

The invention relates to thermoplastic molding compositions comprising:
A) from 10 to 89% by weight of a polyethylene terephthalate or polybutylene terephthalate,
B) from 10 to 60% by weight of a fibrous reinforcing material with a fiber length of from 2 to 24 mm,
C) from 1 to 20% by weight of at least one polyester based on aliphatic and aromatic dicarboxylic acids and on an aliphatic dihydroxy compound,
D) from 0 to 40% by weight of further additives,
   where the entirety of components A) to D) is 100%.

The invention further relates to the use of thermoplastic molding compositions for producing long-fiber-reinforced pellets and to the pellets thus obtainable. The invention further relates to the use of pellets of this type for producing moldings of any type with good notched impact resistance, and to the resultant moldings.

### CROSS-REFERENCE TO RELATED APPLICATIONS

This application claims benefit (under 35 USC 119(e)) of U.S. Provisional Application 61/369,771, filed Aug. 2, 2010 which is incorporated by reference.

### BACKGROUND OF THE INVENTION

The invention relates to thermoplastic molding compositions comprising:
A) from 10 to 89% by weight of a polyethylene terephthalate or polybutylene terephthalate,
B) from 10 to 60% by weight of a fibrous reinforcing material with a fiber length of from 2 to 24 mm,
C) from 1 to 20% by weight of at least one polyester based on aliphatic and aromatic dicarboxylic acids and on an aliphatic dihydroxy compound,
D) from 0 to 40% by weight of further additives,
   where the entirety of components A) to D) is 100%.

The invention further relates to the use of thermoplastic molding compositions for producing long-fiber-reinforced pellets and to the pellets thus obtainable. The invention further relates to the use of pellets of this type for producing moldings of any type with good notched impact resistance, and to the resultant moldings.

Processes for producing long-fiber-reinforced molding compositions and pellets are known by way of example from EP-A 1788027 and 1788028, and 1788029.

A process which has proven particularly successful for producing long-fiber-reinforced thermoplastics (LFTs) is that known as pultrusion. Here, the polymer melt completely saturates the continuous-filament fiber strand (roving), which is then cooled and chopped. The elongate long-fiber-reinforced pellets thus produced can be further processed by the usual processing methods to give moldings.

The combination of good mechanical properties and in particular high HDT (heat distortion temperature) is achieved here by a combination of the specific polyester matrix and particular quantitative glass/polymer proportions.

### BRIEF SUMMARY OF THE INVENTION

A thermoplastic molding composition comprising
A) from 10 to 89% by weight of a polyethylene terephthalate or polybutylene terephthalate,
B) from 10 to 60% by weight of a fibrous reinforcing material with a fiber length of from 2 to 24 mm,
C) from 1 to 20% by weight of at least one polyester based on aliphatic and aromatic dicarboxylic acids and on an aliphatic dihydroxy compound,
D) from 0 to 40% by weight of further additives,
   where the entirety of components A) to D) does not exceed 100%.

The only feature of the moldings made of long-fiber-reinforced thermoplastics which is not fully satisfactory is their impact resistance. It is an object of the present invention to improve the impact resistance of the LFTs, with very substantial retention of mechanical properties.

### DETAILED DESCRIPTION OF THE INVENTION

Accordingly, the molding compositions defined in the introduction have been found. The dependent claims give preferred embodiments.

Surprisingly, addition of a semiaromatic polyester (component C) leads to LFT with better impact resistance. Addition of additives such as flow improvers A1 and A2 markedly improves processing conditions.

The thermoplastic molding compositions of the invention comprise, as component A), amounts of from 10 to 89% by weight, preferably from 15 to 88% by weight, and in particular from 15 to 70% by weight, of at least one thermoplastic polyester.

The polyesters A) used generally comprise those based on aromatic dicarboxylic acids and on an aliphatic or aromatic dihydroxy compound. Preference is given to poly-C₂-C₁₀-alkylene terephthalates, preferably polyethylene terephthalate (PET) and particularly preferably polybutylene terephthalate (PBT).

Polyalkylene terephthalates of this type are known per se and are described in the literature.

A very detailed description of component A (PBT), referring inter alia to the following:
partial replacement of the terephthalic acid by other dicarboxylic acids,
replacement of the aliphatic diol component by aromatic diols (phenols),
polyester block copolymers, copolycarbonates, polycarbonates,
the production of polyesters such as PBT inter alia from recycled materials
   can be found in the specifications WO 2005/075565 and WO 2006/018127, to which express reference is made here.

In one preferred embodiment, the polybutylene terephthalate (component A) comprises from 0.01 to 15% by weight, preferably from 0.3 to 15% by weight, and in particular from 0.5 to 10% by weight, of A1) at least one highly branched or hyperbranched polycarbonate having an OH number of from 1 to 600 mg KOH/g of polycarbonate, preferably from 10 to 550 mg KOH/g of polycarbonate, and in particular from 50 to 550 mg KOH/g of polycarbonate (to DIN 53240, part 2), or at least one hyperbranched polyester, as component A2), or a mixture thereof, as explained below.

For the purposes of this invention, hyperbranched polycarbonates A1) are non-crosslinked macromolecules having hydroxy groups and carbonate groups, these having both structural and molecular non-uniformity. Their structure may firstly be based on a central molecule in the same way as dendrimers, but with non-uniform chain length of the branches. Secondly, they may also have a linear structure with functional pendant groups, or else they may combine the two extremes, having linear and branched molecular portions. See also P. J. Flory, J. Am. Chem. Soc. 1952, 74, 2718, and H. Frey et al., Chem. Eur. J. 2000, 6, no. 14, 2499 for the definition of dendrimeric and hyperbranched polymers.

Component A1) preferably has a number-average molar mass Mn of from 100 to 15 000 g/mol, preferably from 200 to 12 000 g/mol, and in particular from 500 to 10 000 g/mol (GPC, PMMA standard).

The glass transition temperature Tg is in particular from −80° C. to +140° C., preferably from −60 to 120° C. (by DSC, to DIN 53765).

Viscosity (mPas) at 23° C. (to DIN 53019) is in particular from 50 to 200 000, in particular from 100 to 150 000, and very particularly preferably from 200 to 100 000.

The specifications WO 2005/075565 and WO 2006/018127, which are expressly incorporated herein by way of reference, give a very detailed description of component A1 with regard inter alia to
definition of “hyperbranched” and “dendrimeric”,
production process relating to condensates (K) and polycondensates (P),
selection of suitable diol component,
high-functionality polycarbonate,

The inventive molding compositions can comprise, as component A2), at least one hyperbranched polyester of AxBy type, where

x is at least 1.1, preferably at least 1.3, in particular at least 2
y is at least 2.1, preferably at least 2.5, in particular at least 3.

It is, of course, also possible to use mixtures as units A or B.

An AxBy-type polyester is a condensate composed of an x-functional molecule A and a y-functional molecule B. By way of example, mention may be made of a polyester composed of adipic acid as molecule A (x=2) and glycerol as molecule B (y=3).

For the purposes of this invention, hyperbranched polyesters A2) are non-crosslinked macromolecules having hydroxy groups and carboxy groups, these having both structural and molecular non-uniformity. Their structure may firstly be based on a central molecule in the same way as dendrimers, but with non-uniform chain length of the branches. Secondly, they may also have a linear structure with functional pendant groups, or else they may combine the two extremes, having linear and branched molecular portions. See also P. J. Flory, J. Am. Chem. Soc. 1952, 74, 2718, and H. Frey et al., Chem. Eur. J. 2000, 6, no. 14, 2499 for the definition of dendrimeric and hyperbranched polymers.

Component A2) preferably has an Mn of from 300 to 30 000 g/mol, in particular from 400 to 25 000 g/mol, and very particularly from 500 to 20 000 g/mol, determined by means of GPC, PMMA standard, dimethylacetamide eluent.

A2) preferably has an OH number of from 0 to 600 mg KOH/g of polyester, preferably from 1 to 500 mg KOH/g of polyester, in particular from 20 to 500 mg KOH/g of polyester to DIN 53240, and preferably a COOH number of from 0 to 600 mg KOH/g of polyester, preferably from 1 to 500 mg KOH/g of polyester, and in particular from 2 to 500 mg KOH/g of polyester.

Tg is preferably from −50° C. to 140° C., and in particular from −50 to 100° C. (by DSC, to DIN 53765).

Preference is particularly given to those components A2) in which at least one OH or COOH number is greater than 0, preferably greater than 0.1, and in particular greater than 0.5.

Inventive component A2) can be obtained via the processes described in WO 2006/018127, by condensing
(a) one or more dicarboxylic acids or one or more derivatives of the same with one or more at least trihydric alcohols
   or
(b) one or more tricarboxylic acids or higher polycarboxylic acids or one or more derivatives of the same with one or more diols.

WO 2006/018127, which is expressly incorporated herein by way of reference, gives a very detailed description of component A2 with regard inter alia to
the definition of “hyperbranched” and “dendrimeric”,
the preferred production process (see the abovementioned variants a and b)
suitable acid component
suitable alcohol component.

The inventive polyesters have a molar mass M_{w}, of from 500 to 50 000 g/mol, preferably from 1000 to 20 000 g/mol, particularly preferably from 1000 to 19 000 g/mol. Polydispersity is from 1.2 to 50, preferably from 1.4 to 40, particularly preferably from 1.5 to 30, and very particularly preferably from 1.5 to 10. They usually have good solubility, i.e. clear solutions can be prepared using up to 50% by weight, indeed in some cases up to 80% by weight, of the inventive polyesters in tetrahydrofuran (THF), n-butyl acetate, ethanol, and numerous other solvents, without any gel particles detectable by the naked eye.

The inventive high-functionality hyperbranched polyesters are carboxy-terminated, terminated by carboxy groups and by hydroxy groups, and preferably terminated by hydroxy groups.

The ratios of the components A1) to A2) are preferably from 1:20 to 20:1, in particular from 1:15 to 15:1, and very particularly from 1:5 to 5:1, if these are used in a mixture.

The amounts used of the fibrous fillers B) are from 10 to 60% by weight, in particular from 15 to 50% by weight, preferably from 20 to 50% by weight.

Preferred fibrous fillers that may be mentioned are carbon fibers, aramid fibers, glass fibers, and potassium titanate fibers, particular preference being given to glass fibers in the form of E glass. These are used in the form of rovings in the forms commercially available.

The diameter of the glass fibers used in the form of roving in the invention is from 6 to 20 μm, preferably from 10 to 18 μm, and the cross section of these glass fibers can be round, oval, or angular. E glass fibers are in particular used in the invention. However, it is also possible to use any of the other types of glass fiber, examples being A, C, D, M, S, or R glass fibers or any desired mixture thereof, or a mixture with E glass fibers.

The fibrous fillers can have been surface-pretreated with a silane compound in order to improve compatibility with the thermoplastic.

Suitable silane compounds are those of the general formula

(X—(CH₂)ₙ)ₖ—Si—(O—CₘH₂ₘ₊₁)₄₋ₖ

where the definitions of the substituents are as follows:

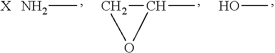

n is an integer from 2 to 10, preferably from 3 to 4
m is an integer from 1 to 5, preferably from 1 to 2
k is an integer from 1 to 3, preferably 1.

Preferred silane compounds are aminopropyltrimethoxysilane, aminobutyltrimethoxysilane, aminopropyltriethoxysilane, aminobutyltriethoxysilane, and also the corresponding silanes which comprise a glycidyl group as substituent X.

The amounts generally used of the silane compounds for surface coating are from 0.01 to 2% by weight, preferably from 0.025 to 1.0% by weight, and in particular from 0.05 to 0.5% by weight (based on E)).

Other suitable coating compositions (also termed size) are based on isocyanates.

The L/D (length/diameter) ratio is preferably from 100 to 4000, in particular from 350 to 2000, and very particularly from 350 to 700.

In principle, the component C used can comprise polyesters that are known as semiaromatic polyesters, based on aliphatic and aromatic dicarboxylic acids and on aliphatic dihydroxy compounds. It is also possible, of course, to use a mixture of a plurality of polyesters of this type, as component C.

In the invention, the term semiaromatic polyesters is intended to include polyester derivatives, such as polyetheresters, polyesteramides, or polyetheresteramides. Among the suitable semiaromatic polyesters are linear non-chain-extended polyesters (WO 92/09654). Preference is given to chain-extended and/or branched semiaromatic polyesters. The latter are known from the specifications WO 96/15173 and WO 2006/074815, and express reference is made to these. Mixtures of various semiaromatic polyesters can likewise be used. The term semiaromatic polyesters in particular includes products such as Ecoflex® (BASF SE), Eastar® Bio and Origo-Bi (Novamont).

Among the particularly preferred semiaromatic polyesters are polyesters which comprise, as essential components,
a) an acid component composed of
   a1) from 35 to 99 mol % of at least one aliphatic, or at least one cycloaliphatic, dicarboxylic acid, or its ester-forming derivatives, or a mixture of these
   a2) from 1 to 65 mol % of at least one aromatic dicarboxylic acid, or its ester-forming derivative, or a mixture of these, and
   a3) from 0 to 5 mol % of a compound comprising sulfonate groups,
b) a diol component selected from at least one C₂-C₁₂ alkanediol and at least one C₈-C₁₀ cycloalkanediol, or a mixture of these,
   and, if desired, also one or more components selected from
c) a component selected from
   c1) at least one dihydroxy compound comprising ether functions and having the formula I

HO—[(CH₂)ₙ—O]ₘ—H (I)
where n is 2, 3 or 4 and m is a whole number from 2 to 250,
c2) at least one hydroxycarboxylic acid of the formula IIa or IIb

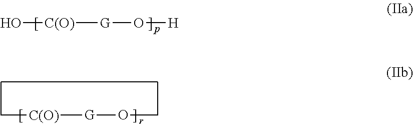

where p is a whole number from 1 to 1500 and r is a whole number from 1 to 4, and G is a radical selected from the group consisting of phenylene, —(CH₂)_{q}—, where q is a whole number from 1 to 5, —C(R)H— and —C(R)HCH₂, where R is methyl or ethyl,
c3) at least one amino-C₂-C₁₂ alkanol, or at least one amino-C₅-C₁₀ cycloalkanol, or a mixture of these,
c4) at least one diamino-C₁-C₈ alkane,
c5) at least one 2,2′-bisoxazoline of the general formula III

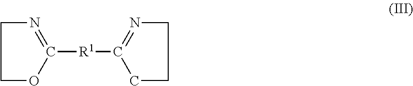

where R¹ is a single bond, a (CH₂)_{z}-alkylene group, where z=2, 3 or 4, or a phenylene group, and
c6) at least one aminocarboxylic acid selected from the group consisting of the naturally occurring amino acids, polyamides obtainable by polycondensing a dicarboxylic acid having from 4 to 6 carbon atoms with a diamine having from 4 to 10 carbon atoms, compounds of the formulae IVa and IVb

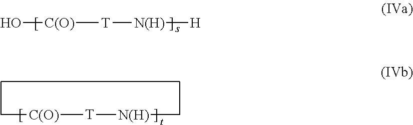

where s is an integer from 1 to 1500 and t is a whole number from 1 to 4, and T is a radical selected from the group consisting of phenylene, —(CH₂)ᵤ—, where u is a whole number from 1 to 12, —C(R²)H— and —C(R²)HCH₂—, where R² is methyl or ethyl,
and polyoxazolines having the repeat unit V

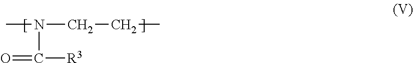

where R³ is hydrogen, C₁-C₆-alkyl, C₅-C₈-cycloalkyl, phenyl, either unsubstituted or with up to three C₁-C₄-alkyl substituents, or tetrahydrofuryl,
or a mixture composed of c1 to c6,
   and
d) a component selected from
   d1) at least one compound having at least three groups capable of ester formation or of amide formation,
   d2) at least one di- or polyfunctional isocyanate
   d3) at least one di- or polyfunctional epoxide, or a mixture of d1) to d3).

In one preferred embodiment, acid component a) of the semiaromatic polyesters comprises from 35 to 70 mol %, in particular from 40 to 60 mol %, of a1, and from 30 to 65 mol %, in particular from 40 to 60 mol %, of a2.

Particular preference is given, as component C) to a copolymer of
ca₁) from 40 to 60% by weight, based on the total weight of components a1) and a2) of at least one succinic, adipic, or sebacic acid, or ester-forming derivatives thereof, or a mixture thereof,
ca₂) from 40 to 60% by weight, based on the total weight of components a1) and a2), of terephthalic acid, or ester-forming derivatives thereof, or a mixture thereof,
cb) 100 mol %, based on components a1) and a2), of 1,4-butanediol or 1,3-propanediol, or a mixture thereof, as diol component,
cd₁) from 0 to 1% by weight of a compound having at least three groups capable of ester formation, as branching agent,
cd₂) from 0 to 2% by weight of a diisocyanate, as chain extender.

The semiaromatic polyesters C mentioned are generally biodegradable.

For the purposes of the present invention, a substance or a mixture of substances complies with the feature termed “biodegradable” if this substance or mixture of substances has a percentage degree of biodegradation of at least 60% in at least one of the three processed defined in DIN V 54900-2 (preliminary standard, as at September 1998).

The preferred semiaromatic polyesters are characterized by a molar mass (Mₙ) in the range from 1000 to 100 000 g/mol, in particular in the range from 9000 to 75 000 g/mol, preferably in the range from 10 000 to 50 000 g/mol, and by a melting point in the range from 60 to 170° C., preferably in the range from 80 to 150° C.

The semiaromatic polyesters mentioned can have hydroxy and/or carboxy end groups in any desired ratio. The semiaromatic polyesters mentioned can also be end-group-modified. By way of example, therefore, OH end groups can be acid-modified via reaction with phthalic acid, phthalic anhydride, trimellitic acid, trimellitic anhydride, pyromellitic acid, or pyromellitic anhydride.

The amounts used of the semiaromatic polyester C are from 1 to 20% by weight, in particular from 5 to 20% by weight, preferably from 8 to 15% by weight.

The thermoplastic molding compositions of the invention can moreover comprise further additives as component D), where they are different from A) to C).

The molding compositions of the invention can comprise, based on the total amount of components A) to D), a total of from 0 to 40% by weight, in particular up to 30% by weight, of further additives and processing aids as component D).

The thermoplastic molding compositions advantageously comprise a lubricant. The molding compositions of the invention can comprise, as component D), from 0 to 3% by weight, preferably from 0.05 to 3% by weight, with preference from 0.1 to 1.5% by weight, and in particular from 0.1 to 1% by weight, of a lubricant, based on the total amount of components A) to D).

Preference is given to the Al, alkali metal, or alkaline earth metal salts, or esters or amides of fatty acids having from 10 to 44 carbon atoms, preferably having from 14 to 44 carbon atoms. The metal ions are preferably alkaline earth metal and Al, particular preference being given to Ca or Mg. Preferred metal salts are Ca stearate and Ca montanate, and also Al stearate. It is also possible to use a mixture of various salts, in any desired mixing ratio.

The carboxylic acids can be monobasic or dibasic. Examples which may be mentioned are pelargonic acid, palmitic acid, lauric acid, margaric acid, dodecanedioic acid, behenic acid, and particularly preferably stearic acid, capric acid, and also montanic acid (a mixture of fatty acids having from 30 to 40 carbon atoms).

The aliphatic alcohols can be monohydric to tetrahydric. Examples of alcohols are n-butanol, n-octanol, stearyl alcohol, ethylene glycol, propylene glycol, neopentyl glycol, pentaerythritol, preference being given to glycerol and pentaerythritol.

The aliphatic amines can be mono- to tribasic. Examples of these are stearylamine, ethylenediamine, propylenediamine, hexamethylenediamine, di(6-aminohexyl)amine, particular preference being given to ethylenediamine and hexamethylenediamine. Preferred esters or amides are correspondingly glycerol distearate, glycerol tristearate, ethylenediamine distearate, glycerol monopalmitate, glycerol trilaurate, glycerol monobehenate, and pentaerythritol tetrastearate.

It is also possible to use a mixture of various esters or amides, or of esters with amides in combination, in any desired mixing ratio.

The thermoplastic molding compositions of the invention can comprise, as further component D), conventional processing aids, such as stabilizers, oxidation retarders, further agents to counter decomposition by heat and decomposition by ultraviolet light, lubricants and mold-release agents, colorants, such as dyes and pigments, nucleating agents, plasticizers, flame retardants, etc.

Examples that may be mentioned of oxidation retarders and heat stabilizers are phosphites and other amines (e.g. TAD), hydroquinones, various substituted representatives of these groups, and mixtures of these, in concentrations of up to 1% by weight, based on the weight of the thermoplastic molding compositions.

UV stabilizers that may be mentioned, where the amounts used of these are generally up to 2% by weight, based on the molding composition, are various substituted resorcinols, salicylates, benzotriazoles, and benzophenones.

Colorants that can be added are inorganic pigments, such as titanium dioxide, ultramarine blue, iron oxide, and carbon black, and/or graphite, and also organic pigments, such as phthalocyanines, quinacridones, perylenes, and also dyes, such as nigrosin, and anthraquinones.

Nucleating agents that can be used are sodium phenylphosphinate, aluminum oxide, silicon dioxide, and also preferably talc.

Flame retardants that may be mentioned are red phosphorus, P- and N-containing flame retardants, and also halogenated flame-retardant systems, and synergists of these.

The thermoplastic molding compositions of the invention can comprise, as component D), from 0.01 to 2% by weight, preferably from 0.05 to 1.5% by weight, particularly preferably from 0.1 to 1.5% by weight, of at least one heat stabilizer, based in each case on the total weight of components A) to D).

The polyester molding compositions of the invention can be produced via the known methods for producing elongate long-fiber-reinforced pellets, in particular via pultrusion processes in which the continuous preheated fiber strand (roving) is drawn at a constant speed through the polymer melt and thus completely saturated by the polymer melt, and is then cooled and chopped. The elongate long-fiber-reinforced pellets thus obtained, preferably with pellet length of from 2 to 25 mm, in particular from 5 to 14 mm, can be further processed by the conventional processing methods (e.g. injection molding, compression molding) to give moldings.

The preferred L/D of the pellets after pultrusion is from 2 to 8, in particular from 3 to 4.5

The polymer strand produced from molding compositions of the invention can be processed by any of the known pelletization methods to give pellets, an example being strand pelletization, in which the strand is cooled in a water bath and is then chopped.

Non-aggressive processing methods can achieve particularly good properties in the molding. Non-aggressive in this context means especially substantial avoidance of excessive fiber fracture and of the attendant severe reduction in fiber length. In the case of injection molding, this means that it is preferable to use screws with large diameter and low compression ratio, in particular smaller than 2, and to use generously dimensioned nozzle channels and feed channels. A complementary factor to which attention should be paid is that high cylinder temperatures are used that rapidly melt the elongate pellets (contact heating) and that the fibers are not excessively comminuted through excessive exposure to shear. When these measures are adopted in the invention, moldings are obtained which have higher average fiber length than comparable moldings produced from short-fiber-reinforced molding compositions. This gives an additional improvement in properties, in particular in relation to tensile modulus of elasticity, alternate tensile strength, and notched impact resistance.

Fiber length after processing of the moldings, e.g. via injection molding, is usually from 0.05 to 10 mm, in particular from 1 to 3 mm.

The moldings produced from the molding compositions of the invention are used to produce internal and external parts, preferably with a load-bearing or mechanical function, in the following sectors: electrical, furniture, sports, mechanical engineering, sanitary and hygiene, medicine, energy technology, and drive technology, automobiles and other conveyances, and casing material for devices and apparatuses for telecommunications, consumer electronics, household appliances, mechanical engineering, or the heating sector, or fastener components for installation work or for containers, and ventilation components of all types.

The moldings of the invention have markedly higher impact resistance, in particular markedly higher notched impact resistance.

### Processing Methods

The following processing methods can be used, alongside the conventional processing methods, such as extrusion or injection molding:
CoBi injection or assembly injection molding for hybrid components, where the polyester molding composition of the invention is combined with other compatible or incompatible materials, e.g. thermoplastics, thermosets, or elastomers.
Insert components, such as bearings or screw-thread inserts made of the polyester molding composition of the invention, overmolded with other compatible or incompatible materials, e.g. thermoplastics, thermosets, or elastomers.
Outsert components, such as frames, casings, or struts made of the polyester molding composition of the invention, into which functional elements made of other compatible or incompatible materials, e.g. thermoplastics, thermosets, or elastomers, are injected.
Hybrid components (elements made of the polyester molding composition of the invention combined with other compatible or incompatible materials, e.g. thermoplastics, thermosets, or elastomers) produced via composite injection molding, injection welding, assembly injection molding, ultrasound welding, frictional welding, or laser welding, adhesive bonding, beading, or riveting.
Semifinished products and profiles (e.g. produced via extrusion, pultrusion, layering, or lamination).
Surface coating, doubling methods, chemical or physical metallization, or flocking, where the polyester molding composition of the invention can be the substrate itself or the substrate support, or, in the case of hybrid/bi-injection components, can be a defined substrate region, which can also be brought to the surface via subsequent chemical treatment (e.g. etching) or physical treatment (e.g. machining or laser ablation).
Printing, transfer print, 3D print, laser inscription.

### Examples

The following components were used:

### Component A:

Ai: Ultradur® 84500 from BASF SE (PBT with viscosity number to DIN 53728 of 130 cm³/g)
Aii: Ultradur® 84520 from BASF SE (PBT with viscosity number to DIN 53728 of 130 cm³/g and 0.65% by weight of pentaerythritol tetrastearate as lubricant)

### Component B:

Long glass fiber (LGF) Bi: glassfiber roving with trademark Adventex®-3B, 2400 tex (tex=g/km of glass fiber), diameter 17 μm, and average fiber length 12 mm.
Short glass fiber (SGF) comp. Bi: PPG 3786 glass fiber from PPG with diameter 10 μm and average fiber length 0.5 mm.
Component C: Polyester i-1 was produced by mixing 87.3 kg of dimethyl terephthalate, 80.3 kg of adipic acid, 117 kg of 1,4-butanediol, and 0.2 kg of glycerol together with 0.028 kg of tetrabutyl orthotitanate (TBOT), where the molar ratio of alcohol components to acid component was 1.30. The reaction mixture was heated to a temperature of 180° C. and reacted at this temperature for 6 h. The temperature was then increased to 240° C., and the excess dihydroxy compound was removed by distillation in vacuo over a period of 3 h. 0.9 kg of hexamethylene diisocyanate was then slowly metered in at 240° C. within a period of 1 h.

The melting point of the resultant polyester i-1 was 119° C. and its molar mass (Mₐ) was 23 000 g/mol (corresponding to Ecoflee FBX 7011, produced by BASF SE).

The molding compositions were produced as follows:

### 1) Long-Fiber-Reinforced Pellets by Pultrusion Process

The polymer melt (components A and C) was mixed in a laterally attached twin-screw extruder at 255° C. and charged at a mass flow rate of 28 kg/h by way of a transition system to the impregnation chamber, the temperature of which was 285° C. The rovings, preheated to 210° C., were pretensioned to avoid contact between the individual glass fibers, and were drawn at a constant speed of from 9 to 12 m/min through the polymer melt and thus completely saturated by the polymer melt; they were then cooled to approximately room temperature and chopped into elongate pellets of length about 12 mm. The L/D ratio of the resultant elongate long-fiber-reinforced pellets was about 4.

### 2) Long-Fiber-Reinforced Test Specimens

The test specimens used to determine properties were produced in a Battenfeld 50 injection-molding machine. The pellets produced in 1) were melted and injected at 6 mm/s into the mold (screw rotation rate 65 rpm, residence time 60 s). The test specimens for the stress tests were produced to ISO 527-2:/1993, and the test specimens for the impact resistance measurements were produced to ISO 179-2/1eA. Injection temperature was 280° C., and melt temperature was 80° C.

### 3) Test Methods and Properties

Charpy notched impact resistance was determined at 23° C. and, respectively, −30° C. to ISO 179-2/1eA.

Yield stress, modulus of elasticity, and tensile strain at break were determined to ISO 527-2:1993. The testing speed was 5 mm/min.

TABLE 1
Effect of component C on unreinforced PBT (comparison)

| Components | Example | Example | Example |
|---|---|---|---|
| [% by weight] | 01 comp | 02 comp | 03 comp |
| Ai) | 100 | 90 | 80 |
| C) | — | 10 | 20 |
| Total | 100 | 100 | 100 |
| Modulus of elasticity [MPa] | 2545 | 1998 | 1616 |
| Tensile strength [MPa] | 58.1 | 47.2 | 39.3 |
| Tensile strain at break [%] | 117.4 | 226.4 | 320.0 |
| Notched Charpy | 6.4 | 6.9 | 9.0 |
| [kJ/m²] at 23° C. | | | |

Table 1 gives the constitutions of the molding compositions and the results of the tests.

TABLE 2
Effect of component C on PBT reinforced with SGF and,
respectively, LGF

| Components | Example | Example | Example | Exam- |
|---|---|---|---|---|
| [% by weight] | 1 comp | 2 comp | 3 comp | ple 4 |
| Aii) | 70 | 60 | 70 | 60 |
| Bi) LGF | | | 30 | 30 |
| comp Bi) SGF | 30 | 30 | | |
| C) | — | 10 | | 10 |
| D) | — | — | — | — |
| Total | 100 | 100 | 100 | 100 |
| Modulus of elasticity [MPa] | 9800 | 7670 | 9126 | 9526 |
| Tensile strength [MPa] | 145 | 96 | 160 | 141 |
| Tensile strain at break [%] | 2.7 | 2.5 | 0.85 | 1.84 |
| Notched Charpy | 10 | 12.2 | 18.2 | 33.8 |
| [kJ/m²] at 23° C. | | | | |
| Notched Charpy | 7.2 | 7.8 | 10.1 | 36.3 |
| [kJ/m²] at −30° C. | | | | |

Table 2 gives the constitutions of the molding compositions and the results of the tests.

The examples show that addition of about 10% by weight of component C gives only a few percent increase in the notched impact resistance of unreinforced polybutylene terephthalate (comparative examples 01 comp to 03 comp). At the same time, addition of component C impairs the tensile strength of the polybutylene terephthalate.

A similar effect can be observed with polybutylene terephthalate reinforced with short glass fibers (SGF) (see example 1 comp versus example 2 comp).

Surprisingly, in the case of the long-glass-fiber-reinforced polybutylene terephthalate of the invention (example 4) notched impact resistance rises dramatically when about 10% by weight of component C is added. At the same time, the good tensile strength of the reinforced polybutylene terephthalate is retained.

1-11. (canceled)

12. A thermoplastic molding composition comprising
A) from 10 to 89% by weight of a polyethylene terephthalate or polybutylene terephthalate,
B) from 10 to 60% by weight of a fibrous reinforcing material with a fiber length of from 2 to 24 mm,
C) from 1 to 20% by weight of at least one polyester based on aliphatic and aromatic dicarboxylic acids and on an aliphatic dihydroxy compound,
D) from 0 to 40% by weight of further additives,
where the entirety of components A) to D) does not exceed 100%.

13. The thermoplastic molding composition according to claim 12, where component
A) comprises from 0.01 to 15% by weight of
A1) at least one highly branched or hyperbranched polycarbonate or
A2) at least one highly branched or hyperbranched polyester or a mixture of these, and
the entirety of components A), A1), A2) to D) does not exceed 100%.

14. The thermoplastic molding composition according to claim 12, in which component B) is composed of glass fibers.

15. The thermoplastic molding composition according to claim 12, in which the L/D ratio of component B) is from 100 to 4000.

16. The thermoplastic molding composition according to claim 13, in which component B) is composed of glass fibers and in which the L/D ratio of component B) is from 100 to 4000.

17. The thermoplastic molding composition according to claim 12, in which component C) is a copolymer of:
C₁) from 40 to 60% by weight, based on the total amount of components C₁) and C₂), of at least one succinic, adipic, or sebacic acid, or ester-forming derivatives thereof, or a mixture thereof,
C₂) from 40 to 60% by weight, based on the total weight of components C₁) and C₂), of terephthalic acid, or ester-forming derivatives thereof, or a mixture thereof,
C₃) from 98 to 102 mol %, based on components C₁) and C₂), of 1,4-butanediol or 1,3-propanediol, or a mixture thereof, as diol component,
C₄) from 0 to 1% by weight, based on component C) of a branching agent, and
C₅) from 0 to 2% by weight, based on component C) of a chain extender.

18. A process for producing long-fiber-reinforced pellets which comprises utilizing the thermoplastic molding compositions according to claim 12.

19. The process according to claim 18, where pultrusion is used for the production of long-fiber-reinforced pellets.

20. A long-fiber-reinforced pellet material obtainable from the thermoplastic molding compositions according to claim 12.

21. The pellet material according to claim 20, the L/D ratio of which is from 2 to 8.

22. A process for producing a molding that has good notched impact resistance which comprises utilizing the pellet according to claim 21.

23. A molding which has good notched impact resistance and which is obtainable from the pellets according to claim 20.
